(19) United States
(12) Patent Application Publication
(10) Pub. No.: US 2003/0090530 A1
(43) Pub. Date: May 15, 2003

(54) Systems and methods for collaborative shape design

(76) Inventors: Karthik Ramani, West Lafayette, IN (US); Abhishek Kumar Agrawal, Evanston, IL (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/237,267

(22) Filed: Sep. 6, 2002

Related U.S. Application Data
(60) Provisional application No. 60/318,222, filed on Sep. 7, 2001.

(51) Int. Cl. G09G 5/00

(52) U.S. Cl. 345/848

(57) ABSTRACT

One embodiment of the present invention provides a computer-implemented method for collaborative shape design in a web-based system having a client and a server. In this embodiment, the method includes obtaining shape information of a shape on the client via a user interface, sending the shape information from the client to the server, generating a three-dimensional (3D) representation of the shape on the server using the shape information, sending the 3D representation of the shape to the client, and displaying the 3D representation of the shape on the client. In one embodiment, the method further includes modifying the 3D representation of the shape on the client, and sending the modified 3D representation of the shape to the server.

### FIELD OF THE INVENTION

The present invention relates to shape design, and more particularly to systems and methods for collaborative shape design.

### BACKGROUND OF THE INVENTION

Today's product development process has witnessed tremendous change in recent years. Product development cycles, as well as their life spans, are getting shorter. More and more outsourcing of components results in increasing coordination and collaboration among various institutions within an enterprise, and across enterprises. Increasing globalization separates various project partners by space and time zones. Moreover, design activity is becoming more and more a joint effort of a highly qualified team. Participants in the design process contribute what they can in their different domains of expertise.

Collaborative shape design systems are slowly becoming a reality with the advent of the Internet and more powerful computers. Collaboration for product shape design, however, requires considerably broader capabilities than most other applications. For example, current computer-aided design (CAD) systems are designed to function as standalone programs. The front end, the libraries, the data, and the processor are present on the same computer. There is a growing need to move from standalone systems to collaborative systems, in which people located in different geographic locations can provide their input concurrently. The architecture for the current CAD systems cannot be extended to make it work in a distributed environment. There are systems that can provide collaborative viewing of a model, but these systems do not provide collaborative shape creation, editing, and deletion, particularly at the client end. Consequently, many aspects of collaborative product shape design have not been realized.

For the reasons stated above, and for other reasons stated below which will become apparent to those skilled in the art upon reading and understanding the present specification, there is a need for the present invention.

### SUMMARY OF THE INVENTION

Various embodiments of the present invention are provided herein. One embodiment of the present invention provides support for product design collaboration over the Internet. This embodiment uses a client-server architecture. A master computer-aided design (CAD) model is kept at the server, and each client has a copy of it. The clients are capable of modifying the copy of the CAD model, and this modification is propagated to the server to synchronize the data. The server modifies the master model and informs the other clients of the changes. The CAD model at the client side can be viewed, manipulated, edited, saved, and deleted. The solid modeling and constraint solving operations are performed at the server side to have thin clients. The thin client and powerful server architecture provide a reduced network load. The client does not need to have high computational power or many installed libraries. Most of the computationally intense operations occur on the server. Clients provide the necessary inputs for these operations, and the server receives these inputs, processes them, generates the output, and sends a simplified model to the appropriate clients.

Another embodiment provides a computer-implemented method for collaborative shape design in a web-based system having a client and a server. In this embodiment, the method includes obtaining shape information of a shape on the client via a user interface, sending the shape information from the client to the server, generating a three-dimensional (3D) representation of the shape on the server using the shape information, sending the 3D representation of the shape to the client, and displaying the 3D representation of the shape on the client. In one embodiment, the method further includes modifying the 3D representation of the shape on the client, and sending the modified 3D representation of the shape to the server.

These and other embodiments will be described in the detailed description below.

### BRIEF DESCRIPTION OF THE DRAWINGS

FIG. 1 shows a block diagram of a distributed system for implementing various embodiments of the present invention.

FIG. 2 shows a block diagram of a server for implementing various embodiments of the present invention.

FIG. 3 shows a block diagram of a client for implementing various embodiments of the present invention.

FIG. 4 shows a block diagram of a multi-client system for implementing various embodiments of the present invention.

FIG. 5 shows a flow diagram of a method for collaborative shape design, according to one embodiment of the present invention.

FIG. 6 shows a flow diagram of a method on a server, according to one embodiment of the present invention.

FIG. 7 shows a flow diagram of a method on a client, according to one embodiment of the present invention.

FIG. 8 shows a flow diagram of a method for collaborative design, according to one embodiment of the present invention.

FIG. 9 shows an example screen display from a client machine, according to one embodiment of the present invention.

FIG. 10 and FIG. I1 show example screen display from a client machine to demonstrate horizontal constraints, according to various embodiments of the present invention.

FIG. 12 and FIG. 13 show example screen display from a client machine to demonstrate vertical constraints, according to various embodiments of the present invention.

FIG. 14 shows an example screen display from a client machine to demonstrate a length constraint, according to one embodiment of the present invention.

FIG. 15 shows an example screen display from a client machine to demonstrate an extrusion depth parameter, according to one embodiment of the present invention.

FIG. 16 shows an example screen display from a client machine of an approximate model, according to one embodiment of the present invention.

FIG. 17A thru FIG. 17C show example screen displays from a client machine of approximate models (including modified models) in three dimensions, according to various embodiments of the present invention.

### DETAILED DESCRIPTION

In the following detailed description of the embodiments, reference is made to the accompanying drawings, which are shown by way of illustration of specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present inventions. It is also to be understood that the various embodiments of the invention, although different, are not necessarily mutually exclusive. For example, a particular feature, structure or characteristic described in one embodiment may be included within other embodiments. The following description is, therefore, not to be taken in a limiting sense.

Various embodiments of the present invention are described herein. One embodiment provides a web-based, platform independent system to collaboratively and synchronously create, delete, and edit shapes. In this embodiment, most of the computationally intensive functionalities (e.g., solid modeling and constraint solving operations) have been transferred to the server in order to reduce the size of the clients. The clients have different privileges in terms of the ability to edit the parts. The system sends data to the clients according to their privileges in order to reduce the network load. A low-level representation is sent if the client doesn't have the privilege to modify the model, while a richer model is sent if the client does have the ability to edit the model.

In another embodiment, a distributed computer-aided design (CAD) system is provided. In this embodiment, the system provides collaborative functionality, and includes a front-end graphical user interface (GUI), a solid modeler, a constraint solver, and other support libraries. The front-end GUI is located on the client, and is used to obtain user input in the form of geometry, parameters, and constraints. In one embodiment, this input contains 3D information. The client transfers these inputs to the server. The server includes the solid modeler and the constraint solver that receive the input from these clients. The server has the intelligence to process these inputs to generate an exact representation of the three-dimensional (3D) solid shape using the solid modeler and the constraint solver. This output is simplified before it is sent to the clients, because the clients can only display polygons (in one embodiment). The model that is sent to a client is also dependent on the type of client. Some clients can only view the model, while others can perform modifications either on the complete model or on a portion of the model. Thus, the model sent to the clients could include editable and/or non-editable parts. These parts have different representations in the model so that the network load can be minimized. An editable part of the model contain, in one embodiment, the polygonal representation of the part, along with an identification number, so that the approximate model can be mapped to the exact 3D model. Any changes made in this fashion to the exact 3D model on the server can then be approximated again and sent to all of the clients. This embodiment has many benefits. Different users located at distant locations are able to do shape design in a collaborative model. The changes made in the model are passed along to clients in real time. Collaborative creation, modification, saving, and deletion of geometry by the clients is supported. A user is able to apply and modify constraints and dimensions on the geometry. Some users have the privilege to make changes in the design, while others are only able to view the model.

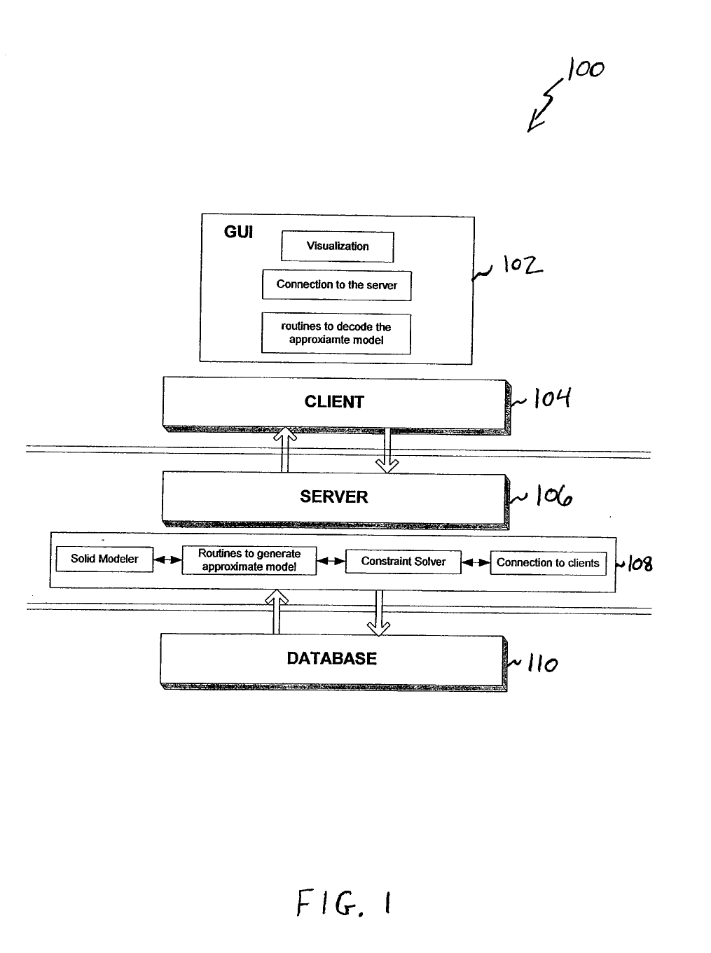

FIG. 1 shows a block diagram of a distributed system for implementing various embodiments of the present invention. System 100 includes client 104, server 106, and database 110. Client 104 includes graphical user interface (GUI) 102, and server 106 includes component 108. Client 104 is communicatively coupled with server 106, and server 106 (with component 108) is communicatively coupled with database 110. GUI 102 includes visualization, functionality to connect to server 106, and routines to decode the approximate model obtained from server 106. Component 108 includes a solid modeler, routines to generate an approximate model, a constraint solver, and functionality to connect to the client. Server 106 is able to communicate with client 104, and one or more additional clients (in one embodiment). In one embodiment, client 104 implements a Model/View/Controller (MVC) pattern with the approximate CAD model as a local model. Database 110 is used to save and retrieve the exact model.

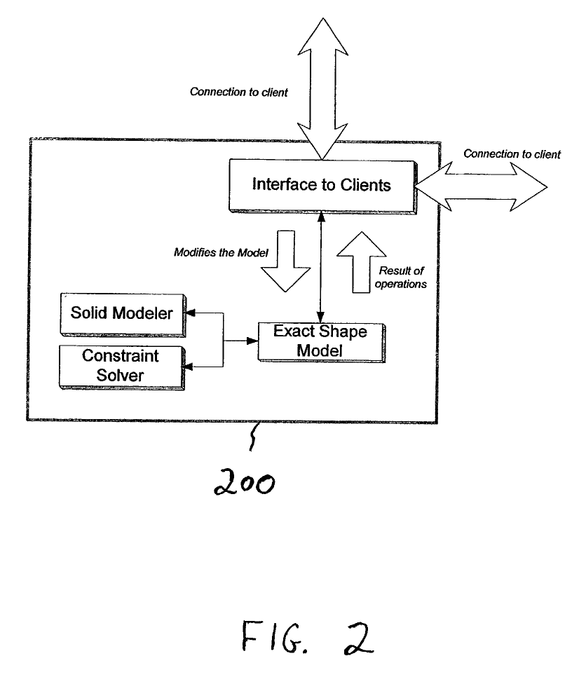

FIG. 2 shows a block diagram of a server for implementing various embodiments of the present invention. Server 200 includes an interface to one or more external clients. Server 200 also includes a solid modeler, a constraint solver, and an exact shape model. The solid modeler and the constraint solver are used to generate the exact shape model. Server 200 provides support to most of the computationally expensive operations, such as solid modeling and constraint solving. In one embodiment, operations using server 200 are as follows. A client is started in a remote location by sending a request to server 200. Server 200 maintains contact with this client at all times during a collaborative session. Server 200 includes the exact model of the shape that is updated by the clients. There is an interface to the clients that processes the command objects sent by the clients (in one embodiment implementing an object-oriented approach). If the operation corresponding to the received command does not require the use of either the solid modeler or the constraint solver, then the model is directly modified by calling the method corresponding to the command, and the command is sent to the rest of the clients to update them. If the operation, however, does require the use of the solid modeler or the constraint solver, then the result of the operation is translated to a new command object, and that object is used to modify the exact model on the server and approximate models on the clients. In other embodiments, a structural approach, rather than an object-oriented approach, is used. In some object-oriented embodiments, different implementations of the command objects are used.

In the embodiment shown in FIG. 2, commands objects are those objects sent between server 200 and clients for communicating data. In one embodiment, command objects are implemented in an interface class called “CommandInterface.” The “CommandInterface” class has two methods:

public void execute (ServerModelInterface s);

public void execute (ClientModelInterface c).

The “ServerModelInterface” class contains all the methods to access and modify the exact model on server 200. The “ClientModelInterface” class contains methods to access the approximate model on the client. If the command object (instantiated from the “CommandInterface” class) is executed by server 200, the method with “ServerModelInterface” is invoked, and if it is executed by the client, the method with “ClientModelInterface” is invoked. A separate command object class is defined for each of the methods that is to be called from a “ServerModelInterface” or a “ClientModelInterface” class (e.g., the command class definition for setting the current state of the model is implemented differently from the command class for setting the current view of the model). In one embodiment, subclasses of the “CommandInterface” class are used to accomplish this. A command object of an appropriate type is created when one of the clients makes changes to the model. That command object is sent to server 200 that calls the “execute” method of the objects, and passes the exact model as an argument. The method in the “ServerModelInterface” class corresponding to that command object is called to make the necessary changes in the model. Then the command object is sent to all other clients. There are situations when a new command object is sent to all the clients, including the one that created the original command object (e.g., when the client requests a section to be extruded, and a new command object is created that keeps the faceted representation of the solid generated after extrusion).

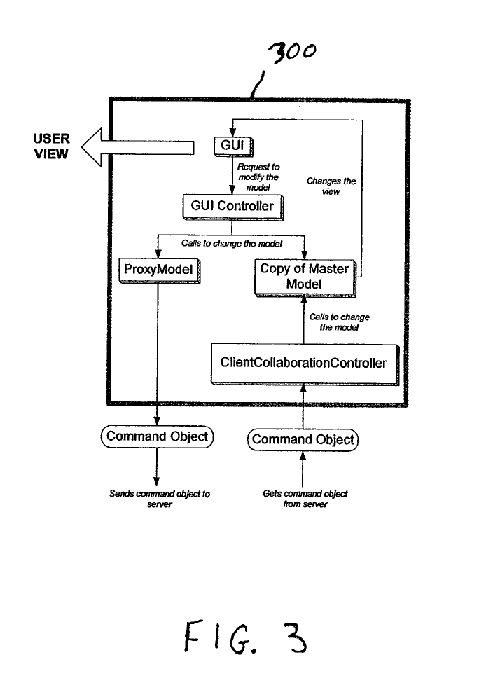

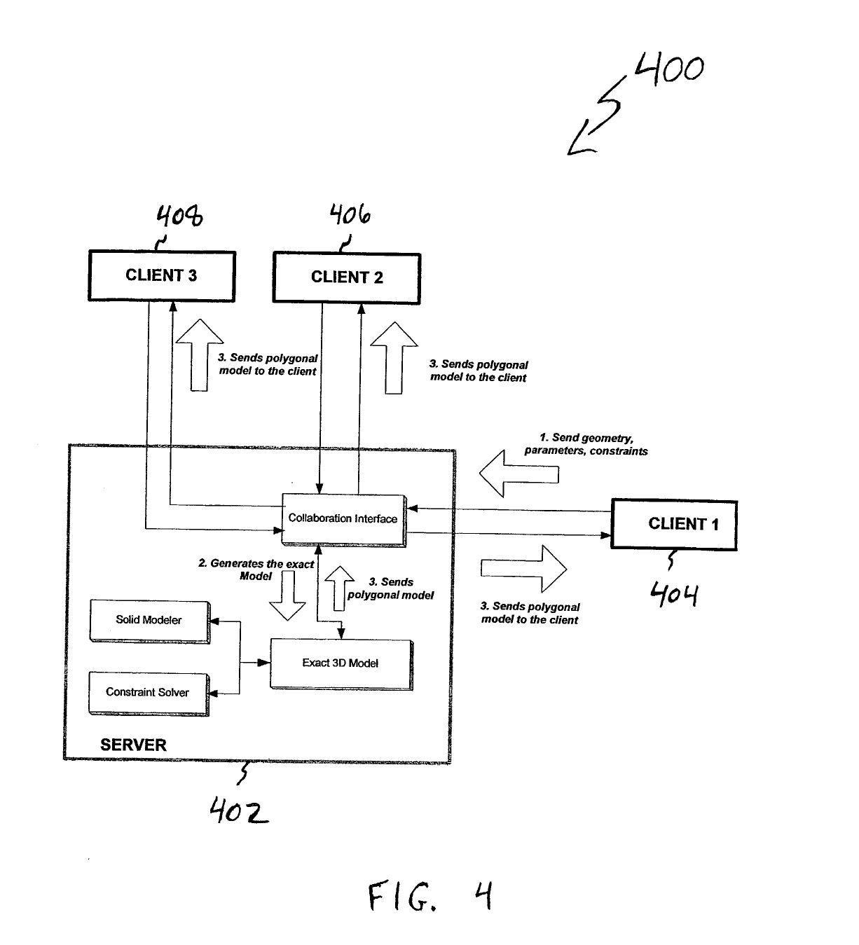

FIG. 3 shows a block diagram of a client for implementing various embodiments of the present invention. Client 300 is structured based on Model/View/Controller (MVC) pattern. MVC contains three kinds of objects. The Model is the application object or the data, the View is its screen presentation, and the Controller defines the way the user interface reacts to user input. MVC increases flexibility and reuse. The Model in the system (in one embodiment) is a faceted representation of the exact shape model that is located on a server. The View is the representation of the model on the GUI in the form of either shaded or wireframe view. The Controllers are the GUI and the “ClientCollaborationController.” The “ClientCollaborationController” takes care of the incoming command objects from the server, and modifies the local model based on the command. The GUI can also modify the model through user interactions. All calls to change the model through the GUI events are translated as methods of the “ClientModelInterface” class. These methods are implemented both in the local shape model on client 300 as well as on a ProxyModel. The ProxyModel translates the called method into a command object and sends that object to the server. The server then modifies the exact model and sends the command to the rest of the clients. In one embodiment, when the server needs to use solid modeling or constraint solving operations, the server processes the command object and sends back the result to all the clients. The “ClientCollaborationController” listens to the command objects sent from the server. It makes the necessary changes in the model depending upon the command objects that it receives from the server.

FIG. 4 shows a block diagram of a multi-client system for implementing various embodiments of the present invention. In FIG. 4, system 400 includes server 402, client 404, client 406, and client 408. Each of clients 404, 406, and 408 are communicatively coupled to server 402. Server 402 includes a solid modeler, a constraint solver, an exact 3D model, and a collaboration interface. The solid modeler and constraint solver are used to generate the exact 3D model. The collaboration interface provides a gateway between the clients and the exact 3D model. When system 400 is operational, one of the clients 404, 406, or 408 creates the inputs necessary to create a shape. The example shown in FIG. 4 illustrates client 404 sending geometry, parameters (e.g., length), or other constraints to server 402. This information is transferred to the collaboration interface on server 402, and is then used to generate an exact representation of the shape using the solid modeler and the constraint solver. A polygonal approximation (in one embodiment) of this exact model is sent to the clients (clients 406 and 408, as shown in FIG. 4) via the collaboration model to display this model. The approximate model may, in one embodiment, include both editable and non-editable parts. This embodiment demonstrates many advantages. The architecture keeps a minimum load on the clients, so that client size and computing power is minimal. The network load is optimized for editable and non-editable portions of the approximate model. Many of the operations required for shape design are available to the clients, and transferring an approximate model, rather than the exact model, reduces network load.

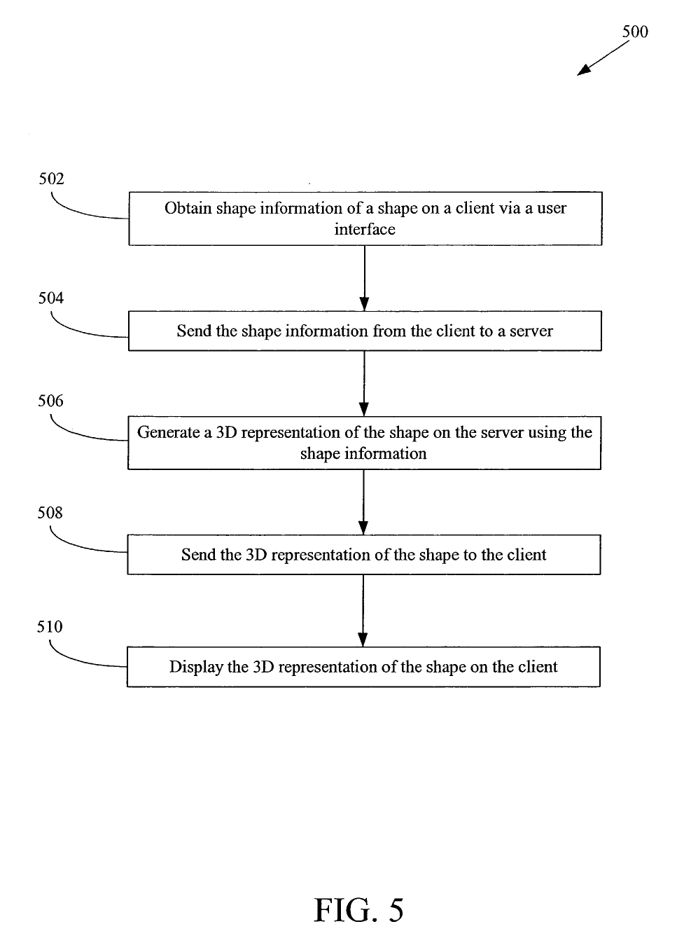

FIG. 5 shows a flow diagram of a method for collaborative shape design, according to one embodiment of the present invention. In this embodiment, method 500 includes obtaining shape information of a shape on the client via a user interface at 502, sending the shape information from the client to the server at 504, generating a three-dimensional (3D) representation of the shape on the server using the shape information at 506, sending the 3D representation of the shape to the client at 508, and displaying the 3D representation of the shape on the client at 510.

In one embodiment, obtaining shape information of a shape on the client via a user interface at 502 includes obtaining shape geometry, parameter, or constraint information. In one embodiment, obtaining shape information of a shape on the client via a user interface at 502 includes obtaining 3D shape information of a shape. In one embodiment, obtaining shape information of a shape on the client via a user interface at 502 includes obtaining shape information of a shape having a set of predetermined constraints.

In one embodiment, generating a three-dimensional (3D) representation of the shape on the server using the shape information at 506 includes using a solid modeler and constraint solver to generate a three-dimensional (3D) representation of the shape.

In one embodiment, sending the 3D representation of the shape to the client at 508 includes sending a simplified 3D representation of the shape to the client.

In one embodiment, method 500 further includes modifying the 3D representation of the shape on the client, and sending the modified 3D representation of the shape to the server. In one embodiment, generating a three-dimensional (3D) representation of the shape on the server using the shape information at 506 includes generating a 3D representation of the shape having a plurality of both editable and non-editable portions, and modifying the 3D representation of the shape on the client includes modifying one or more of the editable portions of the 3D representation of the shape. In one embodiment, modifying the 3D representation of the shape on the client includes using a computer-aided design (CAD) tool. In one embodiment, modifying the 3D representation of the shape on the client includes modifying the 3D representation of the shape using a set of predefined parameters. In one embodiment, modifying the 3D representation of the shape on the client includes modifying a relationship of a first editable portion of the 3D representation of the shape to a second editable portion of the 3D representation of the shape. In one embodiment, modifying a relationship of a first editable portion of the 3D representation of the shape to a second editable portion of the 3D representation of the shape includes modifying a position or an orientation of the first editable portion with respect to the second editable portion of the 3D representation of the shape. In one embodiment, method 500 further includes sending the modified 3D representation of the shape to a second client.

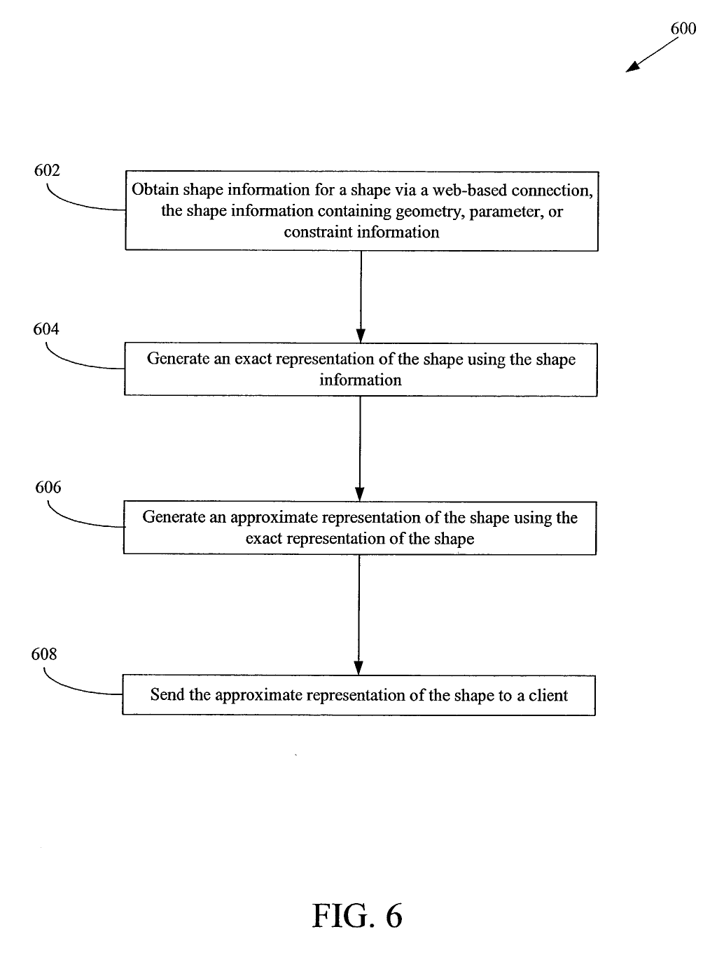

FIG. 6 shows a flow diagram of a method on a server, according to one embodiment of the present invention. In this embodiment, method 600 includes obtaining shape information for a shape via a web-based connection at 602, the shape information containing geometry, parameter, or constraint information, generating an exact representation of the shape using the shape information at 604, generating an approximate representation of the shape using the exact representation of the shape at 606, and sending the approximate representation of the shape to a client at 608.

In one embodiment, obtaining shape information for a shape via a web-based connection at 602 includes obtaining shape information for a shape from the client via a web-based connection. In one embodiment, obtaining shape information for a shape via a web-based connection at 602 includes obtaining three-dimensional (3D) shape information for a shape. In one embodiment, obtaining shape information for a shape via a web-based connection at 602 includes obtaining shape information for a shape having a set of predetermined constraints.

In one embodiment, generating an exact representation of the shape using the shape information at 604 includes using a solid modeler and a constraint solver to generate an exact representation of the shape. In one embodiment, generating an exact representation of the shape using the shape information at 604 includes generating an exact three-dimensional (3D) representation of the shape using the shape information. In one embodiment, generating an approximate representation of the shape using the exact representation of the shape at 606 includes generating an approximate three-dimensional (3D) representation of the shape using the exact representation of the shape.

In one embodiment, generating an approximate representation of the shape using the exact representation of the shape at 606 includes generating an approximate representation of the shape having editable and non-editable portions.

In one embodiment, sending the approximate representation of the shape to the client at 608 includes sending an approximate representation of the shape having polygonal regions to the client. In one embodiment, sending the approximate representation of the shape to the client at 608 includes sending an approximate representation of the shape having editable parts to the client if the client has permission to edit the approximate representation of the shape. In one embodiment, sending the approximate representation of the shape to the client at 608 includes sending an approximate representation of the shape having editable parts to the client, and wherein the method further comprises sending an approximate representation of the shape having non-editable parts to a second client.

In one embodiment, method 600 further includes obtaining a modified approximate representation of the shape from the client, and modifying the exact representation of the shape using the modified approximate representation of the shape. In one embodiment, method 600 further includes generating a modified approximate representation of the shape using the modified exact representation of the shape, and sending the modified approximate representation of the shape to a second client.

In one embodiment, method 600 is embodied in computer-executable instructions that are stored on a computer-readable medium. In one embodiment, the computer-readable medium is a storage entity, such as a floppy diskette, a compact disc (CD-R or CD-RW, for example), a hard disk, or the like.

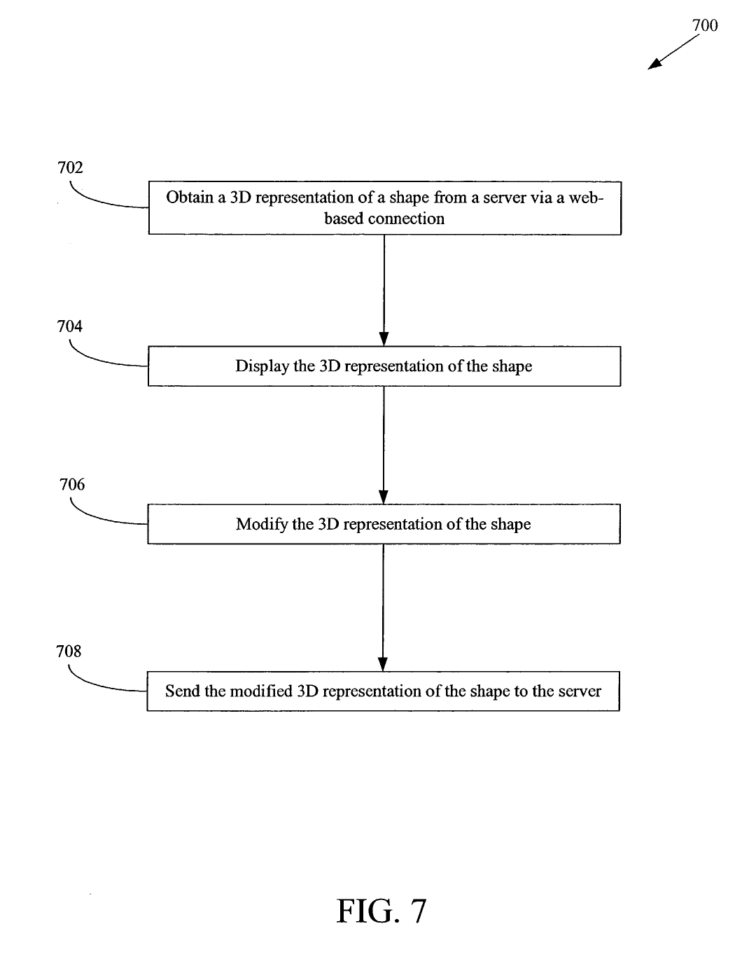

FIG. 7 shows a flow diagram of a method on a client, according to one embodiment of the present invention. In this embodiment, method 700 includes obtaining a three-dimensional (3D) representation of a shape from a server via a web-based connection at 702, displaying the 3D representation of the shape at 704, modifying the 3D representation of the shape at 706, and sending the modified 3D representation of the shape to the server at 708. The modified 3D representation is capable of being used to update a master 3D representation of the shape on the server.

In one embodiment, obtaining a three-dimensional (3D) representation of a shape from the server via a web-based connection at 702 includes obtaining a 3D representation of a shape having editable and non-editable portions, and modifying the 3D representation of the shape at 706 includes modifying only the editable portions of the 3D representation of the shape.

In one embodiment, modifying the 3D representation of the shape at 706 includes adding 3D annotations on the 3D representation of the shape. In one embodiment, modifying the 3D representation of the shape at 706 includes using a computer-aided design (CAD) tool. In one embodiment, modifying the 3D representation of the shape at 706 includes modifying the 3D representation of the shape using a set of predefined parameters. In one embodiment, modifying the 3D representation of the shape at 706 includes modifying a relationship of a first editable portion of the 3D representation of the shape to a second editable portion of the 3D representation of the shape. In one embodiment, modifying a relationship of a first editable portion of the 3D representation of the shape to a second editable portion of the 3D representation of the shape includes modifying a position or an orientation of the first editable portion with respect to the second editable portion of the 3D representation of the shape.

In one embodiment, method 700 further includes obtaining shape information for the shape via a user interface, and sending the shape information to the server. In one embodiment, obtaining shape information for the shape via a user interface includes obtaining geometry, parameter, or constraint information. In one embodiment, obtaining shape information for the shape via a user interface includes obtaining shape information for the shape having a set of predetermined constraints.

In one embodiment, method 700 is embodied in computer-executable instructions that are stored on a computer-readable medium. In one embodiment, the computer-readable medium is a storage entity, such as a floppy diskette, a compact disc (CD-R or CD-RW, for example), a hard disk, or the like.

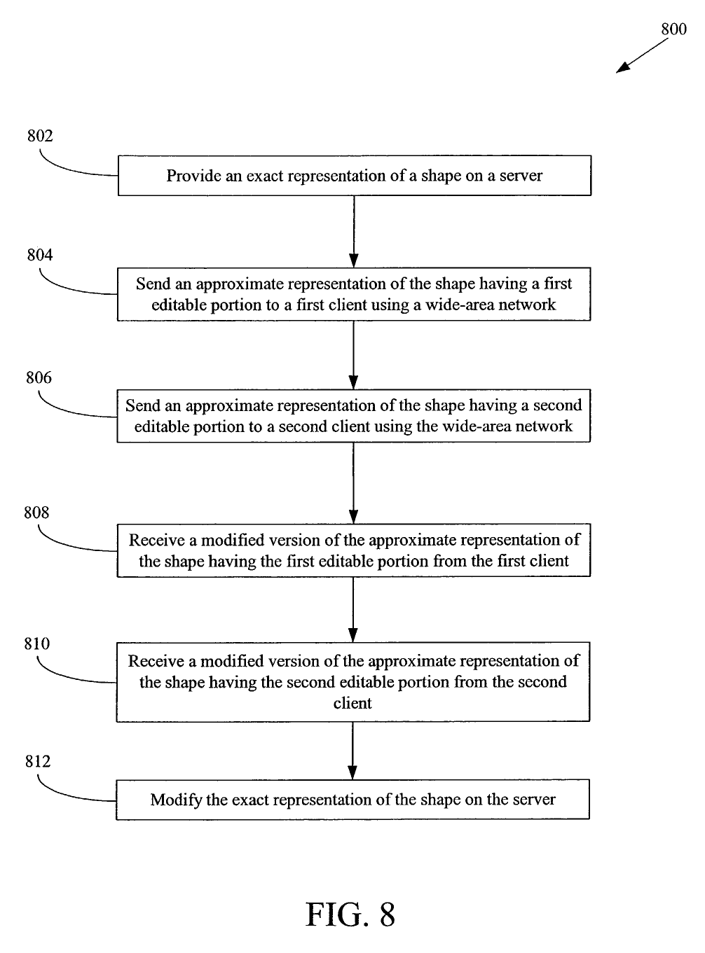

FIG. 8 shows a flow diagram of a method for collaborative design, according to one embodiment of the present invention. In this embodiment, method 800 includes providing an exact representation of a shape on a server at 802, sending an approximate representation of the shape having a first editable portion to a first client using a wide-area network at 804, sending an approximate representation of the shape having a second editable portion to a second client using the wide-area network at 806, receiving a modified version of the approximate representation of the shape having the first editable portion from the first client at 808, receiving a modified version of the approximate representation of the shape having the second editable portion from the second client at 810, and modifying the exact representation of the shape on the server at 812.

In one embodiment, providing an exact representation of a shape on a server at 802 includes providing an exact three-dimensional (3D) representation of a shape on a server.

In one embodiment, sending an approximate representation of the shape having a first editable portion to a first client using a wide-area network at 804 includes sending an approximate representation of the shape having a first editable portion to a first client using the Internet.

In one embodiment, method 800 further includes sending the modified version of the exact representation of the shape to the first and second clients.

In one embodiment, method 800 is embodied in computer-executable instructions that are stored on a computer-readable medium. In one embodiment, the computer-readable medium is a storage entity, such as a floppy diskette, a compact disc (CD-R or CD-RW, for example), a hard disk, or the like.

Another embodiment of the present invention provides a collaborative shape design system. In this embodiment, the system includes a server having program modules for computationally intensive shape design operations, a client having program modules for less computationally intensive shape design operations on shape defining data, and a data model maintained at the server including a set of modifiable shapes defining data. The server includes a program module for sending to the client a subset of modifiable shape defining data. In one embodiment, the collaborative shape design system includes a computer-aided design (CAD) system. In one embodiment, the server includes a program module for solid modeling and constraint solving operations. In one embodiment, the client includes a program module for sending user data to the server, the user data containing shape geometry, parameter, or constraint information.

Another embodiment of the present invention provides a collaborative shape design system. In this embodiment, the system includes a server having program modules for computationally intensive shape design operations, a client having program modules for less computationally intensive shape design operations on shape defining data, and a data model maintained at the server having a set of modifiable shapes defining data for each of a number of parts of an overall shape. The server includes a program module for sending to the client shape defining data with an indication of which parts the server is authorized to modify.

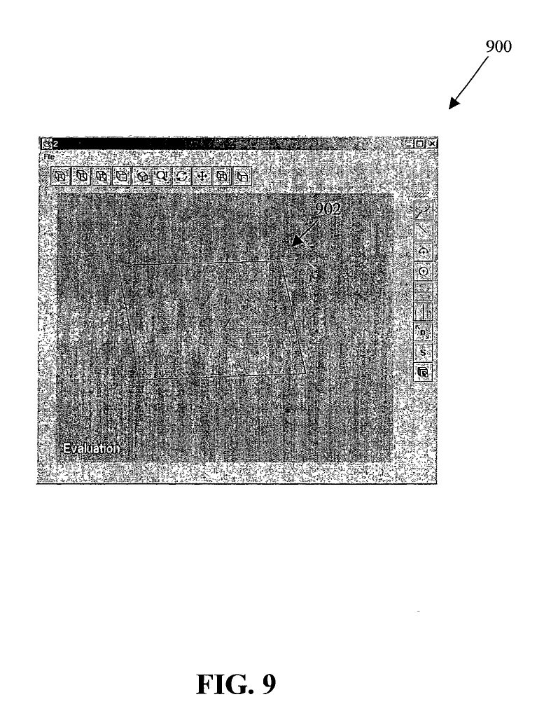

FIG. 9 shows an example screen display from a client machine, according to one embodiment of the present invention. In FIG. 9, screen display 900 is shown on the client using a GUI, in one embodiment. Screen display 900 includes shape 902. Shape 902 is shown in polygonal form in FIG. 9. Shape 902 includes, in one embodiment, geometry, parameter, and/or constraint information. This information can be sent to a server so that an exact 3D model of shape 902 can be generated.

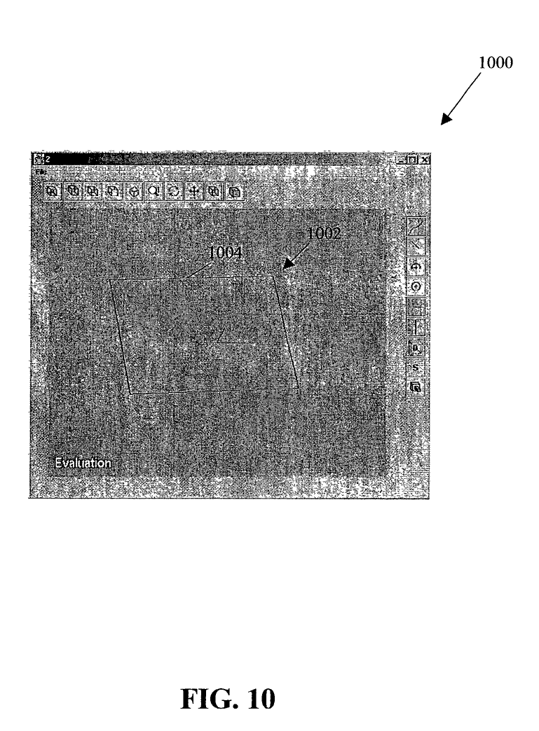

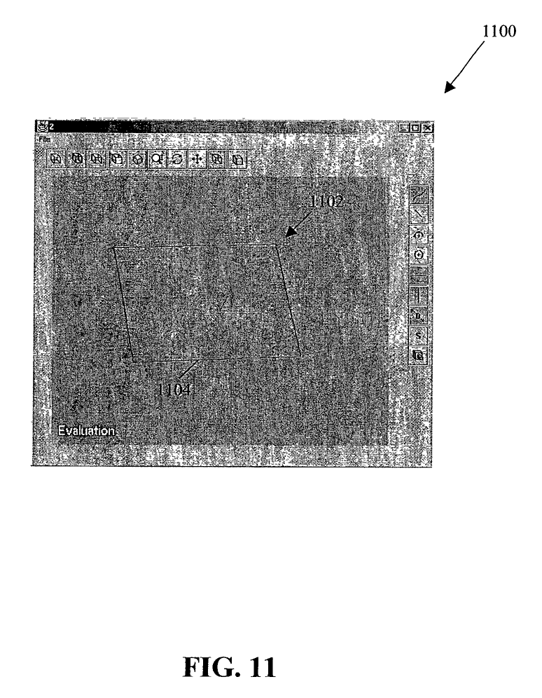

FIG. 10 and FIG. 11 show example screen display from a client machine to demonstrate horizontal constraints, according to various embodiments of the present invention. In FIG. 10, screen display 1000 includes shape 1002. Shape 1002 includes horizontal constraint 1004. Information for horizontal constraint 1004 is sent to a server to be processed by a constraint solver. In FIG. 1, screen display 1100 includes shape 1102. Shape 1102 includes horizontal constraint 1104. Information for horizontal constraint 1104 is also sent to a server to be processed by a constraint solver. In one embodiment, the constraint information contains 3D information.

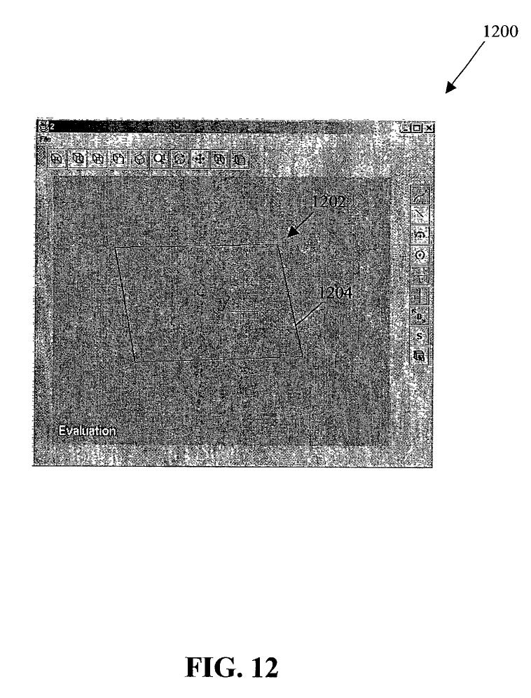

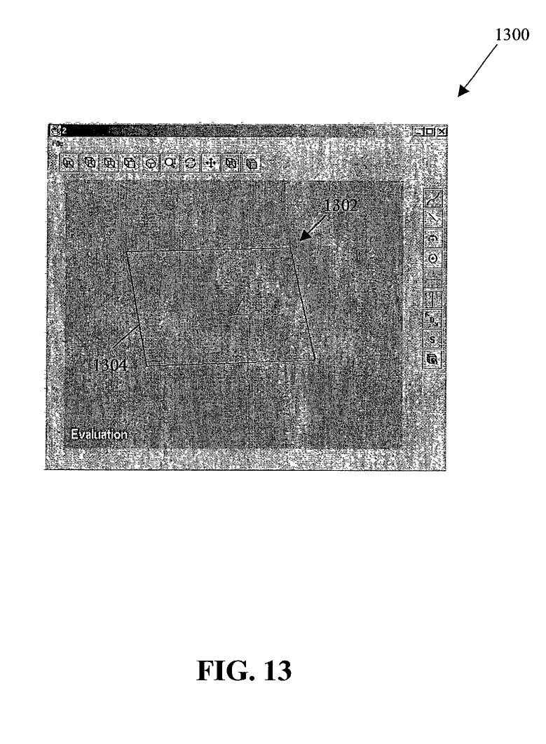

FIG. 12 and FIG. 13 show example screen display from a client machine to demonstrate vertical constraints, according to various embodiments of the present invention. In FIG. 12, screen display 1200 includes shape 1202. Shape 1202 includes vertical constraint 1204. Information concerning vertical constraint 1204 is sent to a server to be processed by a constraint solver. In FIG. 13, screen display 1300 includes shape 1302. Shape 1302 includes vertical constraint 1304. Information concerning vertical constraint 1304 is also sent to server to be processed by a constraint solver. In one embodiment, the constraint information contains 3D information.

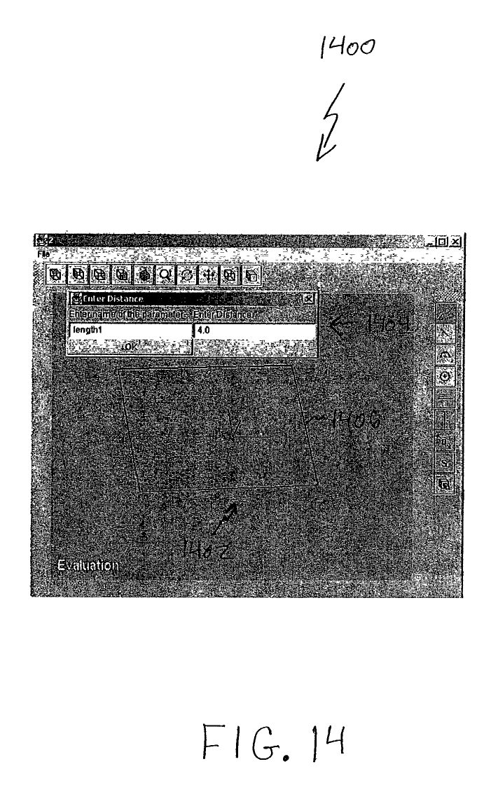

FIG. 14 shows an example screen display from a client machine to demonstrate a length constraint, according to one embodiment of the present invention. In FIG. 14, screen display 1400 includes shape 1402 and dialog box 1404. Shape 1402 includes portion 1406. A user may utilize dialog box 1404 to set the length of portion 1406. As shown in FIG. 4, the length of portion 1406 has been set to “4.0.” This length constraint information can be sent to a server so that it may be processed by a constraint solver.

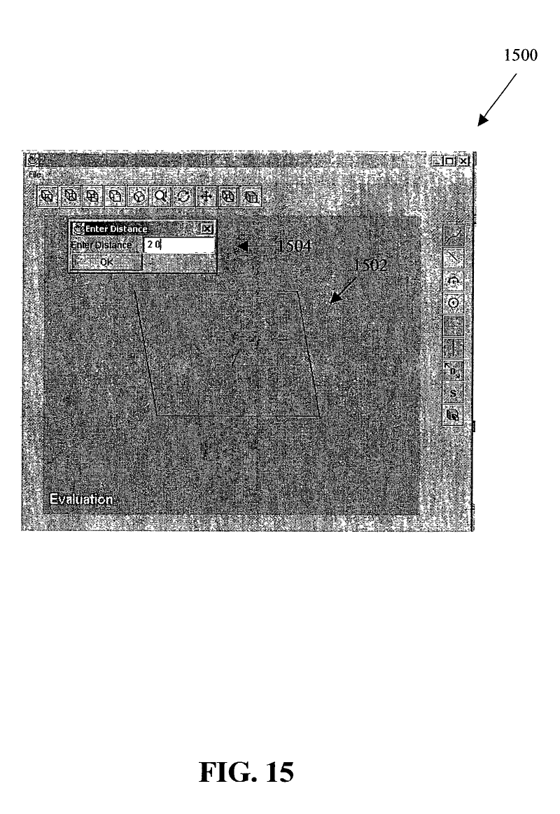

FIG. 15 shows an example screen display from a client machine to demonstrate an extrusion depth parameter, according to one embodiment of the present invention. In FIG. 15, screen display 1500 includes shape 1502 and dialog box 1504. A user may utilize dialog box 1504 to set an extrusion depth parameter. Once set, shape 1502 will be extruded by this depth value in the direction of positive normal (in one embodiment). This information is then also sent to a server, which uses the information to assist in generating an exact 3D model. As shown in FIG. 15, the extrusion depth parameter has been set to a value of “2.0.”

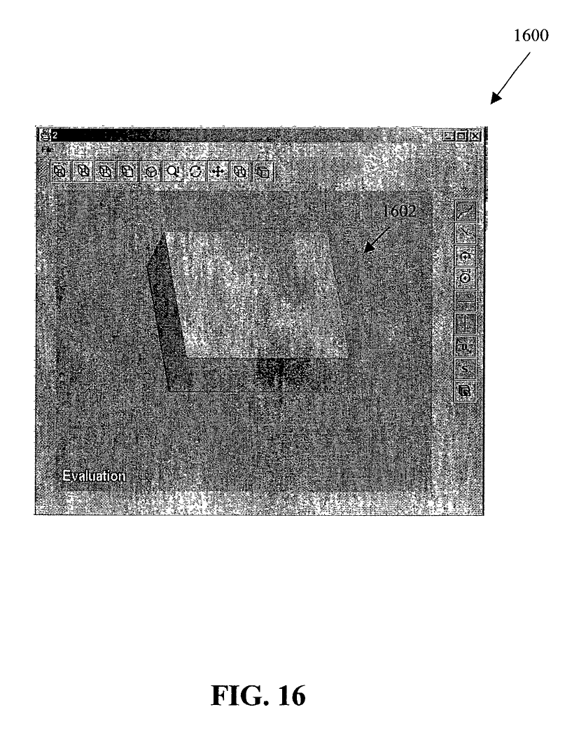

FIG. 16 shows an example screen display from a client machine of an approximate model, according to one embodiment of the present invention. In FIG. 16, screen display 1600 includes approximate model 1602. In this embodiment, approximate model 1602 is a polygonal model. In one embodiment, the model is displayed in 3D. Approximate model 1602 has been generated from an exact model on a server and sent to the client for display and/or modification purposes.

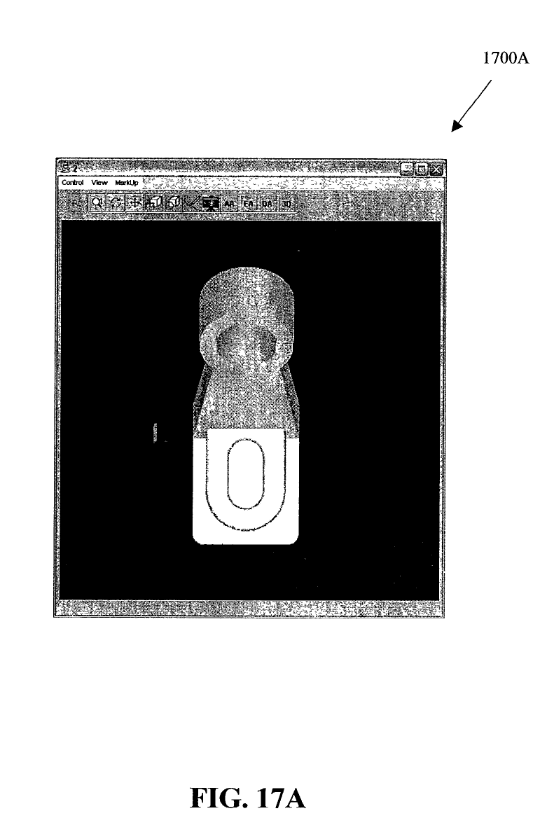

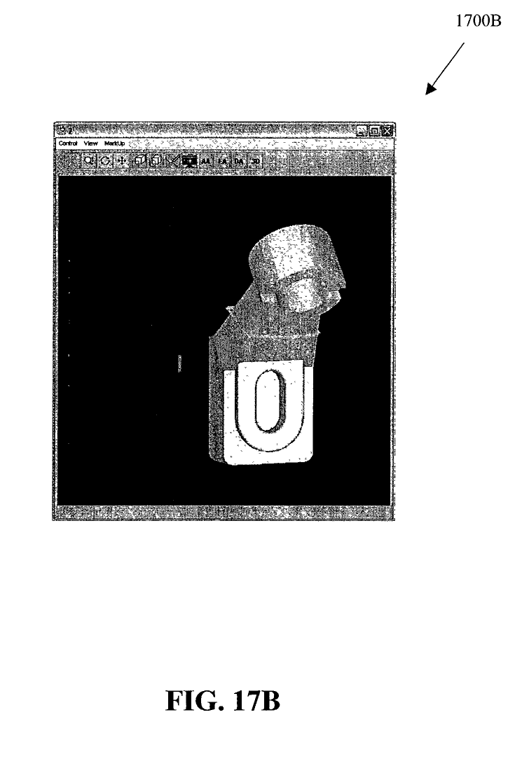

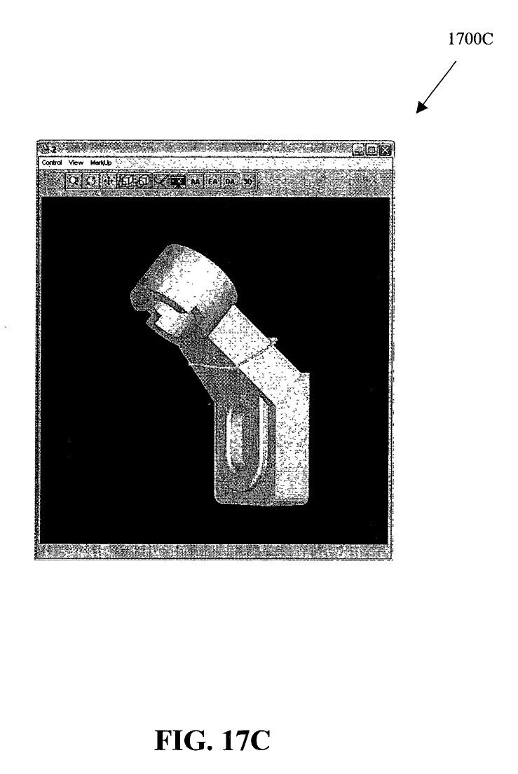

FIG. 17A thru FIG. 17C show example screen displays from a client machine of approximate models (including modified models) in three dimensions, according to various embodiments of the present invention. In FIG. 17A, screen display 1700A shows a 3D approximate model that has been received by the client. This 3D approximate model has been generated from an exact 3D model by a server, and sent to the client via a web-based connection (in one embodiment). In FIG. 17B, screen display 1700B shows a modified 3D approximate model. This model has been modified by the client, and is sent to the server (in one embodiment) so that the exact 3D model on the server may be updated. In FIG. 17C, screen display 1700C shows a modified 3D approximate model from a different perspective view (as displayed on the client machine).

Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the described embodiments of the present invention.

What is claimed is:

1. A computer-implemented method for collaborative shape design in a web-based system having a client and a server, the method comprising:
obtaining shape information of a shape on the client via a user interface;
sending the shape information from the client to the server;
generating a three-dimensional (3D) representation of the shape on the server using the shape information;
sending the 3D representation of the shape to the client; and
displaying the 3D representation of the shape on the client.

2. The computer-implemented method of claim 1, wherein obtaining shape information of a shape on the client via a user interface includes obtaining shape geometry, parameter, or constraint information.

3. The computer-implemented method of claim 1, wherein obtaining shape information of a shape on the client via a user interface includes obtaining 3D shape information of a shape.

4. The computer-implemented method of claim 1, wherein obtaining shape information of a shape on the client via a user interface includes obtaining shape information of a shape having a set of predetermined constraints.

5. The computer-implemented method of claim 1, wherein generating a three-dimensional (3D) representation of the shape on the server using the shape information includes using a solid modeler and constraint solver to generate a three-dimensional (3D) representation of the shape.

6. The computer-implemented method of claim 1, wherein sending the 3D representation of the shape to the client includes sending a simplified 3D representation of the shape to the client.

7. The computer-implemented method of claim 1, wherein the method further comprises:
modifying the 3D representation of the shape on the client; and
sending the modified 3D representation of the shape to the server.

8. The computer-implemented method of claim 7, wherein generating a three-dimensional (3D) representation of the shape on the server using the shape information includes generating a 3D representation of the shape having a plurality of both editable and non-editable portions, and wherein modifying the 3D representation of the shape on the client includes modifying one or more of the editable portions of the 3D representation of the shape.

9. The computer-implemented method of claim 7, wherein modifying the 3D representation of the shape on the client includes using a computer-aided design (CAD) tool.

10. The computer-implemented method of claim 7, wherein modifying the 3D representation of the shape on the client includes modifying the 3D representation of the shape using a set of predefined parameters.

11. The computer-implemented method of claim 7, wherein modifying the 3D representation of the shape on the client includes modifying a relationship of a first editable portion of the 3D representation of the shape to a second editable portion of the 3D representation of the shape.

12. The computer-implemented method of claim 11, wherein modifying a relationship of a first editable portion of the 3D representation of the shape to a second editable portion of the 3D representation of the shape includes modifying a position or an orientation of the first editable portion with respect to the second editable portion of the 3D representation of the shape.

13. The computer-implemented method of claim 7, wherein the method further comprises sending the modified 3D representation of the shape to a second client.

14. A computer-implemented method on a server, the method comprising:
obtaining shape information for a shape via a web-based connection, the shape information containing geometry, parameter, or constraint information;
generating an exact representation of the shape using the shape information;
generating an approximate representation of the shape using the exact representation of the shape; and
sending the approximate representation of the shape to a client.

15. The computer-implemented method of claim 14, wherein obtaining shape information for a shape via a web-based connection includes obtaining shape information for a shape from the client via a web-based connection.

16. The computer-implemented method of claim 14, wherein obtaining shape information for a shape via a web-based connection includes obtaining three-dimensional (3D) shape information for a shape.

17. The computer-implemented method of claim 14, wherein obtaining shape information for a shape via a web-based connection includes obtaining shape information for a shape having a set of predetermined constraints.

18. The computer-implemented method of claim 14, wherein generating an exact representation of the shape using the shape information includes using a solid modeler and a constraint solver to generate an exact representation of the shape.

19. The computer-implemented method of claim 14, wherein generating an exact representation of the shape using the shape information includes generating an exact three-dimensional (3D) representation of the shape using the shape information.

20. The computer-implemented method of claim 19, wherein generating an approximate representation of the shape using the exact representation of the shape includes generating an approximate three-dimensional (3D) representation of the shape using the exact representation of the shape.

21. The computer-implemented method of claim 14, wherein generating an approximate representation of the shape using the exact representation of the shape includes generating an approximate representation of the shape having editable and non-editable portions.

22. The computer-implemented method of claim 14, wherein sending the approximate representation of the shape to a client includes sending an approximate representation of the shape having polygonal regions to a client.

23. The computer-implemented method of claim 14, wherein sending the approximate representation of the shape to a client includes sending an approximate representation of the shape having editable parts to a client if the client has permission to edit the approximate representation of the shape.

24. The computer-implemented method of claim 14, wherein sending the approximate representation of the shape to a client includes sending an approximate representation of the shape having editable parts to a client, and wherein the method further comprises sending an approximate representation of the shape having non-editable parts to a second client.

25. The computer-implemented method of claim 14, wherein the method further comprises:
obtaining a modified approximate representation of the shape from the client; and
modifying the exact representation of the shape using the modified approximate representation of the shape.

26. The computer-implemented method of claim 25, wherein the method further comprises:
generating a modified approximate representation of the shape using the modified exact representation of the shape; and
sending the modified approximate representation of the shape to a second client.

27. The computer-implemented method of claim 14, wherein the method is embodied in computer-executable instructions that are stored on a computer-readable medium.

28. A computer-implemented method on a client, the method comprising:
obtaining a three-dimensional (3D) representation of a shape from a server via a web-based connection;
displaying the 3D representation of the shape;
modifying the 3D representation of the shape; and
sending the modified 3D representation of the shape to the server,
wherein the modified 3D representation is capable of being used to update a master 3D representation of the shape on the server.

29. The computer-implemented method of claim 28, wherein
obtaining a three-dimensional (3D) representation of a shape from the server via a web-based connection includes obtaining a 3D representation of a shape having editable and non-editable portions, and wherein
modifying the 3D representation of the shape includes modifying only the editable portions of the 3D representation of the shape.

30. The computer-implemented method of claim 28, wherein modifying the 3D representation of the shape includes adding 3D annotations on the 3D representation of the shape.

31. The computer-implemented method of claim 28, wherein modifying the 3D representation of the shape includes using a computer-aided design (CAD) tool.

32. The computer-implemented method of claim 28, wherein modifying the 3D representation of the shape includes modifying the 3D representation of the shape using a set of predefined parameters.

33. The computer-implemented method of claim 28, wherein modifying the 3D representation of the shape includes modifying a relationship of a first editable portion of the 3D representation of the shape to a second editable portion of the 3D representation of the shape.

34. The computer-implemented method of claim 33, wherein modifying a relationship of a first editable portion of the 3D representation of the shape to a second editable portion of the 3D representation of the shape includes modifying a position or an orientation of the first editable portion with respect to the second editable portion of the 3D representation of the shape.

35. The computer-implemented method of claim 28, wherein the method further comprises:
obtaining shape information for the shape via a user interface; and
sending the shape information to the server.

36. The computer-implemented method of claim 35, wherein obtaining shape information for the shape via a user interface includes obtaining geometry, parameter, or constraint information.

37. The computer-implemented method of claim 35, wherein obtaining shape information for the shape via a user interface includes obtaining shape information for the shape having a set of predetermined constraints.

38. The computer-implemented method of claim 28, wherein the method is embodied in computer-executable instructions that are stored on a computer-readable medium.

39. A computer-implemented method for collaborative design, the method comprising:
providing an exact representation of a shape on a server;
sending an approximate representation of the shape having a first editable portion to a first client using a wide-area network;
sending an approximate representation of the shape having a second editable portion to a second client using the wide-area network;
receiving a modified version of the approximate representation of the shape having the first editable portion from the first client;
receiving a modified version of the approximate representation of the shape having the second editable portion from the second client; and
modifying the exact representation of the shape on the server.

40. The computer-implemented method of claim 39, wherein providing an exact representation of a shape on a server includes providing an exact three-dimensional (3D) representation of a shape on a server.

41. The computer-implemented method of claim 39, wherein sending an approximate representation of the shape having a first editable portion to a first client using a wide-area network includes sending an approximate representation of the shape having a first editable portion to a first client using the Internet.

42. The computer-implemented method of claim 39, wherein the method further comprises sending the modified version of the exact representation of the shape to the first and second clients.

43. The computer-implemented method of claim 39, wherein the method is embodied in computer-executable instructions that are stored on a computer-readable medium.

44. A distributed computer-aided design (CAD) system, comprising:
a client; and
a server coupled to the client,
wherein the client includes client software operable thereon to:
obtain shape information for a shape via a user interface;
send the shape information to the server;
obtain a three-dimensional (3D) representation of the shape from the server; and
display the 3D representation of the shape; and
wherein the server includes server software operable thereon to:
obtain shape information for a shape from the client;
generate a 3D representation of the shape using the shape information; and
send the 3D representation of the shape to the client.

45. The distributed CAD system of claim 44, wherein the server is coupled to the client via a web-based connection.

46. The distributed CAD system of claim 44, wherein the shape information includes shape geometry, parameter, or constraint information.

47. The distributed CAD system of claim 44, wherein
the client software is further operable on the client to:
modify the 3D representation of the shape; and
send the modified 3D representation of the shape to the server; and wherein
the server software is further operable on the server to:
obtain a modified 3D representation of the shape from the client.

48. A system, comprising:
a server having a web-based external interface; and
software operable on the server to:
obtain shape information for a shape via the web-based external interface,
the shape information containing geometry, parameter, or constraint information;
generate an exact representation of the shape using the shape information;
generate an approximate representation of the shape using the exact representation of the shape; and
send the approximate representation of the shape to a client via the web-based external interface.

49. The system of claim 48, wherein the software operable on the server to obtain shape information for a shape via the web-based external interface includes software obtain shape information for a shape from the client via the web-based external interface.

50. A collaborative shape design system, comprising:
a server including program modules for computationally intensive shape design operations;
a client including program modules for less computationally intensive shape design operations on shape defining data;
a data model maintained at the server including a set of modifiable shapes defining data; and
the server including a program module for sending to the client a subset of modifiable shape defining data.

51. The collaborative shape design system of claim 50, wherein the collaborative shape design system includes a computer-aided design (CAD) system.

52. The collaborative shape design system of claim 50, wherein the server includes a program module for solid modeling and constraint solving operations.

53. The collaborative shape design system of claim 50, wherein the client includes a program module for sending user data to the server, the user data containing shape geometry, parameter, or constraint information.

54. A collaborative shape design system, comprising:
a server including program modules for computationally intensive shape design operations;
a client including program modules for less computationally intensive shape design operations on shape defining data;
a data model maintained at the server including a set of modifiable shapes defining data for each of a plurality of parts of an overall shape; and
the server including a program module for sending to the client shape defining data with an indication of which parts the server is authorized to modify.
